(19) United States
(12) Patent Application Publication
(10) Pub. No.: US 2021/0070563 A1
(43) Pub. Date: Mar. 11, 2021

(54) ATTACHMENT STRUCTURE AND IMAGE FORMING APPARATUS

(71) Applicant: FUJI XEROX CO., LTD., Tokyo (JP)

(72) Inventors: Shumpei NOZAWA, Kanagawa (JP); Yoichi YAMAKAWA, Kanagawa (JP)

(73) Assignee: FUJI XEROX CO., LTD., Tokyo (JP)

(21) Appl. No.: 16/814,393

(22) Filed: Mar. 10, 2020

(30) Foreign Application Priority Data
Sep. 11, 2019 (JP) 2019-165496

(51) Int. Cl. B65H 1/04; B65H 1/14; B65H 29/12; B65H 31/26

(52) U.S. Cl. CPC B65H 1/04; B65H 31/26; B65H 29/125; B65H 1/14

(57) ABSTRACT

An attachment structure includes: a shaft part via which a plate-like member is supported on a body in a manner capable of being opened or closed; a torsion spring that is fitted on the shaft part with one end thereof fixed to the plate-like member and that exerts a damping force when the plate-like member is brought to an open state; and a bracket having a bearing portion that is fixed to the body and supports the shaft part and a reaction-force receiving portion that receives a reaction force exerted by another end of the torsion spring.

### CROSS-REFERENCE TO RELATED APPLICATIONS

This application is based on and claims priority under 35 USC 119 from Japanese Patent Application No. 2019-165496 filed Sep. 11, 2019.

### BACKGROUND

### (i) Technical Field

The present disclosure relates to an attachment structure and an image forming apparatus.

### (ii) Related Art

Japanese Unexamined Patent Application Publication No. 2007-050972 discloses a manual paper-feed device. A tray of this manual paper-feed device is rotatably supported on a unit case via first and second arms. When the tray is closed, the bottom surface of the tray is flush with the exterior surface of a body. A torsion coil spring is fitted on a shaft of the first arm to serve as a damper when the tray is opened. The shaft is located so as not to interfere with a sheet transport path extending from a sheet insertion port, and the torsion coil spring can be disposed inside the unit case.

Japanese Unexamined Patent Application Publication No. 2016-133615 discloses an image forming apparatus. A manual tray is supported on an image-forming body such that it can be opened and closed. In the image forming apparatus, a power spring provided on the image-forming body urges the manual tray against the weight thereof or the like via a wire attached at one end thereof to the manual tray to reduce an impact caused when the manual tray is opened.

Japanese Unexamined Patent Application Publication No. 2016-109781 discloses a sheet loading device. A third discharge tray is provided on an open/close door, which is opened or closed with respect to a body, and a stopper for the third discharge tray and a damper unit that resists when the open/close door is opened and closed are provided. The damper unit reduces the opening speed of the open/close door.

### SUMMARY

Aspects of non-limiting embodiments of the present disclosure relate to providing an attachment structure and an image forming apparatus in which the parts count is reduced, compared with a configuration in which a bearing and a spring presser are formed as separate members.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an attachment structure including: a shaft part via which a plate-like member is supported on a body in a manner capable of being opened or closed; a torsion spring that is fitted on the shaft part with one end thereof fixed to the plate-like member and that exerts a damping force when the plate-like member is brought to an open state; and a bracket having a bearing portion that is fixed to the body and supports the shaft part and a reaction-force receiving portion that receives a reaction force exerted by another end of the torsion spring.

### BRIEF DESCRIPTION OF THE DRAWINGS

Exemplary embodiments of the present disclosure will be described in detail based on the following figures, wherein:

FIG. 1 is a perspective view of an image forming apparatus having an attachment structure according to a first exemplary embodiment;

FIG. 2 is a perspective view of a plate-like member according to the first exemplary embodiment;

FIG. 3 is a perspective view of the attachment structure according to the first exemplary embodiment;

FIG. 4 is a perspective view showing the relevant part of a frame constituting member according to the first exemplary embodiment;

FIG. 5 is a perspective view of a shaft part according to the first exemplary embodiment;

FIG. 6 is a perspective view of a torsion spring according to the first exemplary embodiment;

FIG. 7 is a perspective view of a bracket according to the first exemplary embodiment;

FIG. 8 is a perspective view of the attachment structure according to the first exemplary embodiment, as viewed from the left side;

FIG. 9 is a perspective view of the attachment structure according to the first exemplary embodiment, as viewed from the right side;

FIG. 10 is an explanatory diagram of the relevant part, showing an opening/closing operation of the plate-like member according to the first exemplary embodiment; and

FIG. 11 is a perspective view of a bracket according to a second exemplary embodiment.

### DETAILED DESCRIPTION

### First Exemplary Embodiment

Now, a first exemplary embodiment will be described with reference to the drawings. In the description below, the directions indicated by arrows X and Y in the drawings will be referred to as the width and height directions, respectively. The direction perpendicular to the width and height directions (the direction indicated by arrow Z) will be referred to as the depth direction.

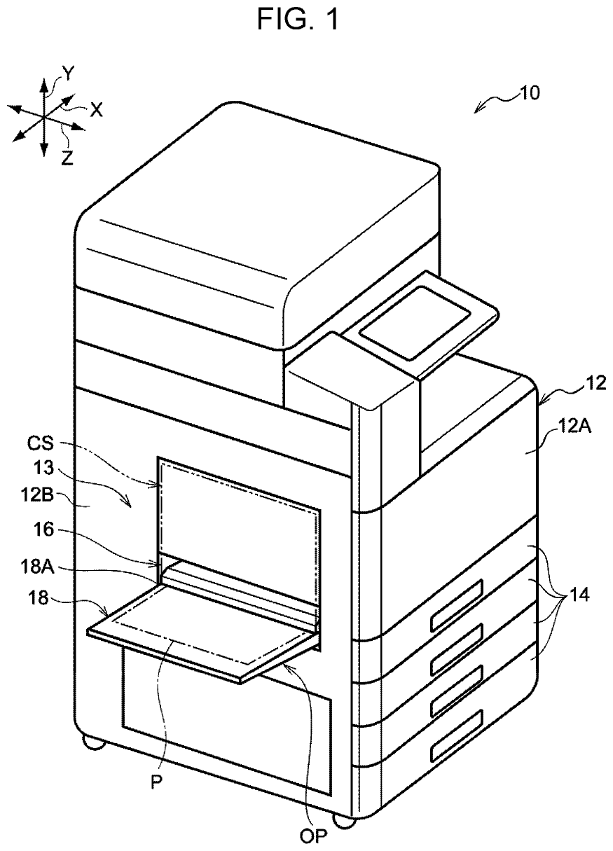

FIG. 1 is a perspective view of an image forming apparatus 10 having an attachment structure according to this exemplary embodiment. The image forming apparatus 10 forms an image on a medium P. A body 12 of the image forming apparatus 10 includes an image forming part (not shown) that forms an image on the medium P, and a transport part (not shown) that transports the medium P to the image forming part.

The medium P may also be referred to as a sheet or a film on which an image is formed. The medium P includes a sheet of paper or an OHP sheet of polyethylene terephthalate (PET) resin.

The medium P on which an image is to be formed is supplied from a sheet storage part 14 accommodated in a front side 12A of the body 12 such that it can be pulled out. Alternatively, the medium P can be supplied from a manual tray part 13 provided on a side surface of the body 12.

A sheet supply port 16, through which a medium P is supplied, is provided in a side surface 12B of the body 12. A base end portion 18A of a plate-like member 18 is supported at the lower part of the sheet supply port 16. The plate-like member 18 can be either in a closed state CS, in which it is extends along the side surface 12B, and an open state OP, in which it projects sideward from the side surface 12B and is inclined such that the distal end thereof is higher than the base end portion.

### Plate-Like Member

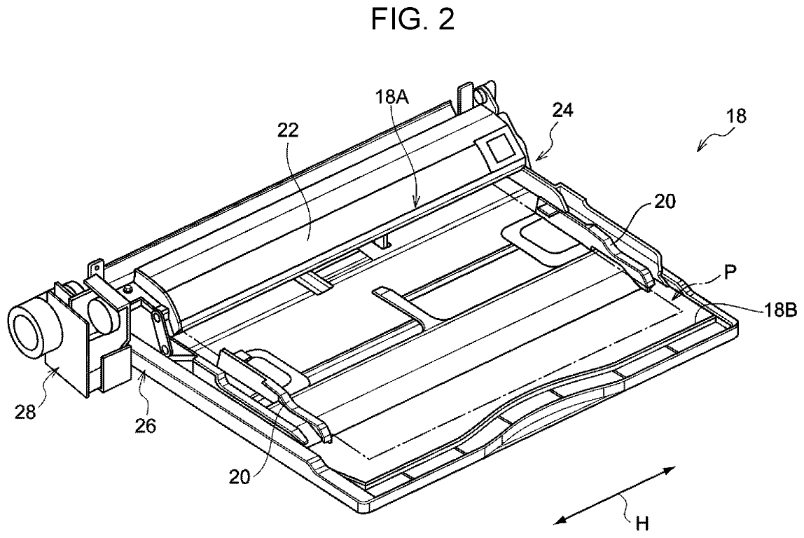

The plate-like member 18 is made of a synthetic resin. As shown in FIG. 2, the plate-like member 18 has a size sufficient to support the medium P. A pair of width guides 20 that guide the side edges of the medium P placed on the plate-like member 18 are provided on a top surface 18B so as to be slidable in the width direction H.

The plate-like member 18 constitutes a tray used to supply a medium P on which an image is formed. The plate-like member 18 may also be referred to as a tray or a manual tray used to supply a desired medium P.

The base end portion 18A of the plate-like member 18 is covered with a cover 22. An attachment structure (described below) is provided below the cover 22, on a one side portion 24 side of the plate-like member 18. A mechanism 28 for transporting the medium P into the body 12 is provided on another side portion 26 side of the plate-like member 18. When the mechanism 28 is actuated, a medium P on the plate-like member 18 is supplied into the body 12 through the sheet supply port 16, and an image is formed on the medium P.

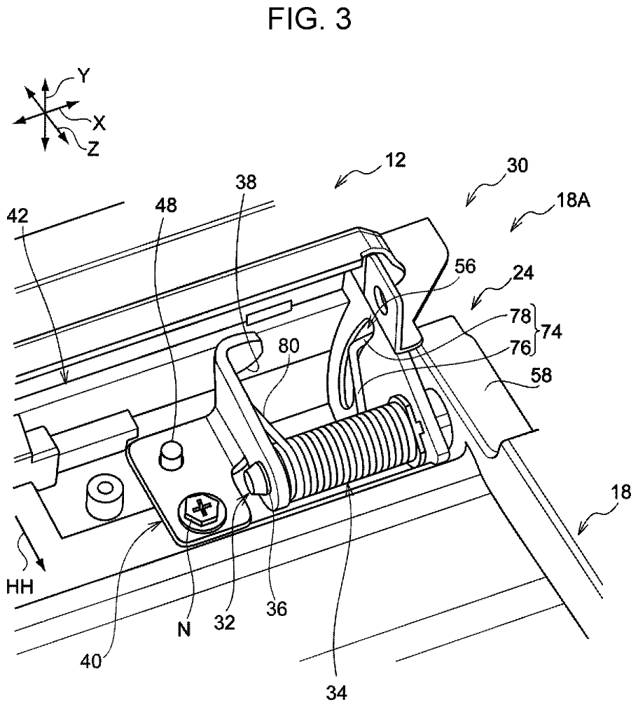

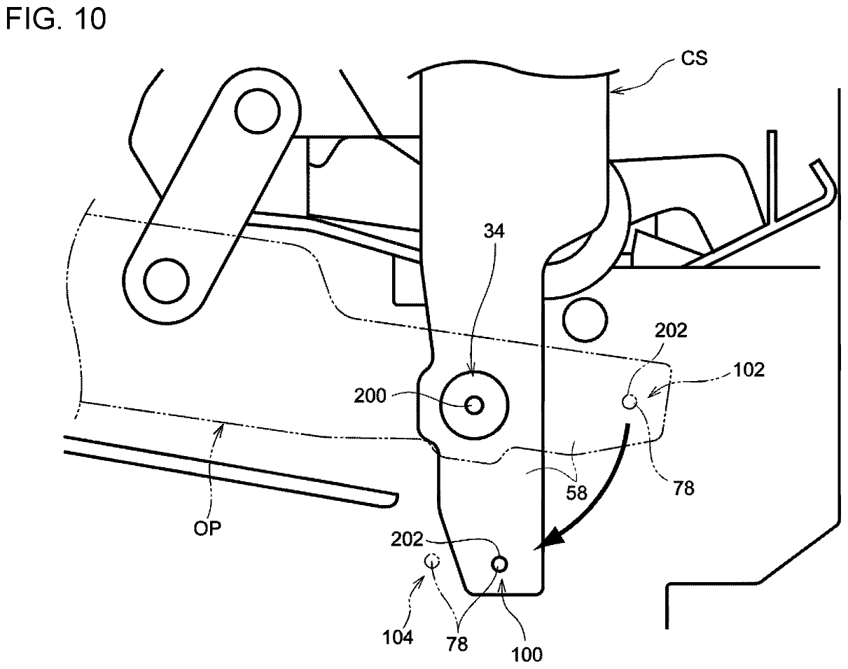

As shown in FIGS. 3 and 10, arm portions 58 are provided on both sides of the base end portion 18A of the plate-like member 18. The arm portions 58 each have a support hole 200 that receives a shaft part 32 (described below) and a spring hole 202 (described below) that receives a one-side extending portion 78, which constitutes a one-end portion 74 of the torsion spring 34.

FIG. 3 is a perspective view showing the structure of an attachment part 30 via which the plate-like member 18 is attached to the body 12. FIG. 3 shows the one side portion 24 side of the plate-like member 18 without the cover 22 and in the open state OP.

The attachment part 30 includes a shaft part 32 that supports the plate-like member 18 in a manner capable of being opened or closed with respect to the body 12, and a torsion spring 34 fitted on the shaft part 32 and fixed at one end to the plate-like member 18. The torsion spring 34 generates a damping force when the plate-like member 18 is brought to the open state OP. The attachment part 30 also includes a bracket 40 having a bearing portion 36 that is fixed to the body 12 and supports the shaft part 32 and a reaction-force receiving portion 38 that receives a reaction force exerted by the other-end portion of the torsion spring 34. The bracket 40 is fixed to the body 12 via a frame component 42.

### Frame Component

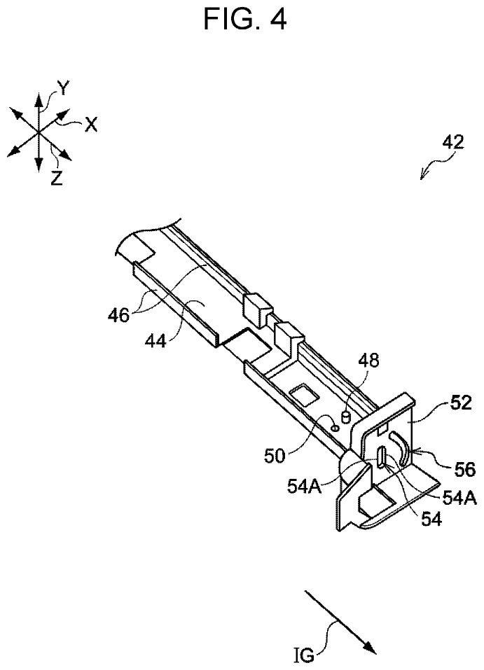

The frame component 42 is formed of a synthetic resin. As shown in FIGS. 3 and 4, the frame component 42 includes a long, plate-like base 44 fixed to the body 12 so as to extend in the depth direction Z of the body 12, and reinforcement flanges 46 formed on the edges of the base 44 extending in the longitudinal direction.

The base 44 has, at one end thereof, a cylindrical projection 48 and a circular screw hole 50. An upright wall 52 is provided on one end side IG of the projection 48 and the screw hole 50.

The upright wall 52 has an insertion hole 54 that receives the shaft part 32. The insertion hole 54 has an elliptical (oval) shape with linear portions 54A, which are linear edges extending along the longitudinal axis.

The upright wall 52 also has an arc-shaped hole 56 centered at the insertion hole 54. The arc-shaped hole 56 is located closer to the body 12 than the insertion hole 54 is, when the frame component 42 is fixed to the body 12.

### Shaft Part

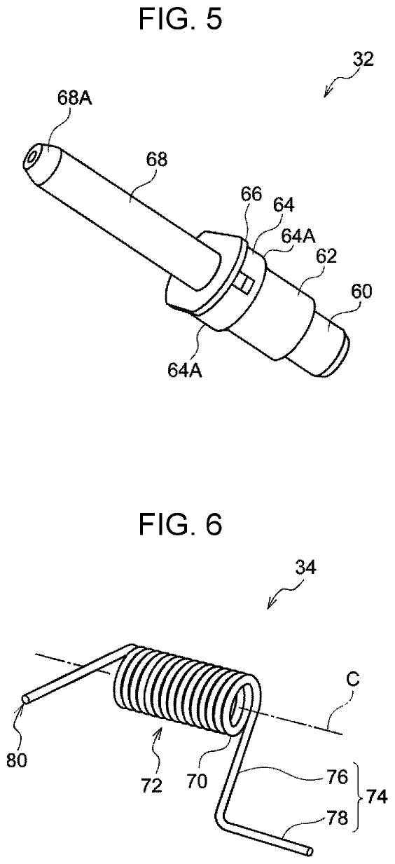

The shaft part 32 is formed of a synthetic resin. As shown in FIGS. 3 and 5, the shaft part 32 has, at one end thereof, a cylindrical insertion portion 60 to be rotatably inserted into the arm portion 58 extending from the end of the plate-like member 18. A cylindrical large-diameter portion 62 having a larger diameter than the insertion portion 60 is formed at the other end of the insertion portion 60.

A rotation stopper 64 having a larger diameter than the large-diameter portion 62 is formed at the other end of the large-diameter portion 62. The rotation stopper 64 has an elliptical shape so as to be inserted into the insertion hole 54 in the frame component 42, and the rotation stopper 64 has planar portions 64A that come into contact with the linear portions 54A of the insertion hole 54.

A shaft flange 66 projecting outward is provided at the other end of the rotation stopper 64. The shaft flange 66 restricts the movement of the shaft part 32 toward the insertion hole 54 in the insertion direction. A cylindrical fitting shaft 68, on which the torsion spring 34 is fitted, is formed at the other end of the shaft flange 66. The fitting shaft 68 has a chamfered portion 68A at the end so that the torsion spring 34 can be easily fitted.

### Torsion Spring

As shown in FIGS. 3 and 6, the torsion spring 34 has a coil portion 72, in which a steel wire 70 is spirally wound.

The one-end portion 74 of the steel wire 70 extends from one end of the coil portion 72. The one-end portion 74 includes a sideward-extending portion 76 extending linearly sideward from the coil portion 72 and a one-side extending portion 78 extending linearly toward one side from the sideward-extending portion 76. The one-side extending portion 78 passes through the arc-shaped hole 56 in the frame component 42 and is inserted into the arm portion 58 of the plate-like member 18.

Another-end portion 80 of the steel wire 70 extends linearly sideward from the coil portion 72 from the other end of the coil portion 72.

The torsion spring 34 may also referred to as a coil spring or a torsion coil spring, which is an example of the coil spring, that generates a spring force when the one-end portion 74 or the other-end portion 80 is twisted about the central axis C of the coil portion 72. The spring force generated in the torsion spring 34 is the damping force mentioned above.

### Bracket

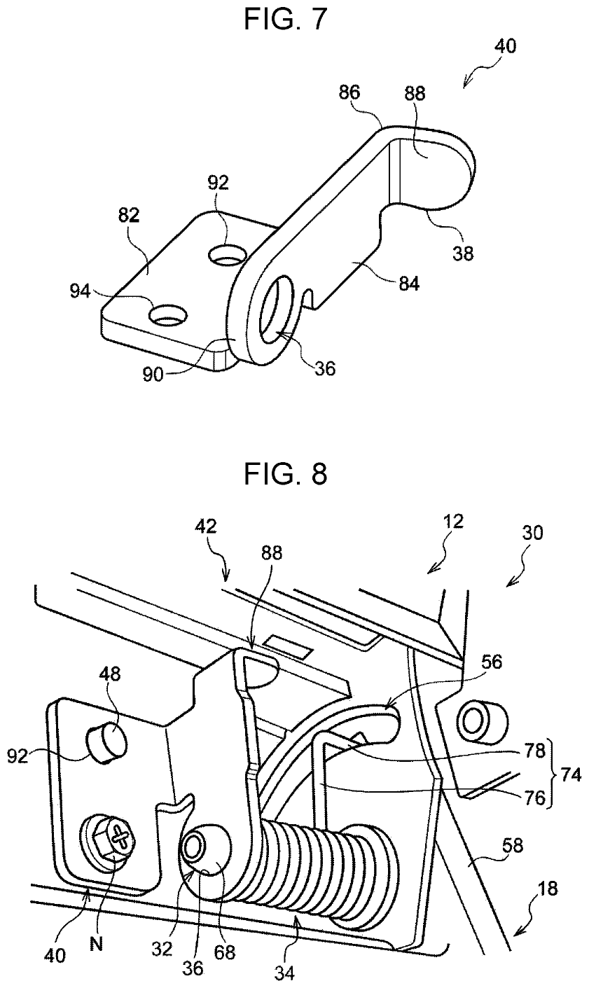

As shown in FIGS. 3 and 7, the bracket 40 is formed by bending a metal plate.

The bracket 40 has a rectangular fixing portion 82 fixed to the body 12 via the frame component 42, and a rectangular upright portion 84 standing upright from a long side of the fixing portion 82 and constituting the bearing portion 36. The bracket 40 also has a side-edge extending portion 88 extending from one side edge 86 of the upright portion 84 in the longitudinal direction, toward the side opposite from the fixing portion 82 in the thickness direction of the upright portion 84. The side-edge extending portion 88 constitutes the reaction-force receiving portion 38.

The upright portion 84 has, on another side edge 90 side, a circular hole constituting the bearing portion 36. The bearing portion 36 receives and supports the fitting shaft 68 of the shaft part 32. The side-edge extending portion 88 extends from the one side edge 86, which is opposite from the other side edge 90 having the bearing portion 36.

The fixing portion 82 has two fixing holes: a positioning hole 92 that receives the projection 48 provided on the frame component 42 fixed to the body 12 in an attached state, and a screw hole 94 that receives a fixing screw N. The screw hole 94 is located farther from the side surface 12B of the body 12 than the positioning hole 92 is, in a direction HH.

### Attachment Process

When the plate-like member 18 is attached to the body 12, the shaft part 32 is inserted into the insertion hole 54 in the frame component 42 fixed to the body 12, the rotation stopper 64 is inserted into the insertion hole 54, and the insertion portion 60 is inserted into the arm portion 58 of the plate-like member 18. Thus, the plate-like member 18 is supported on the body 12 in a manner capable of being opened or closed.

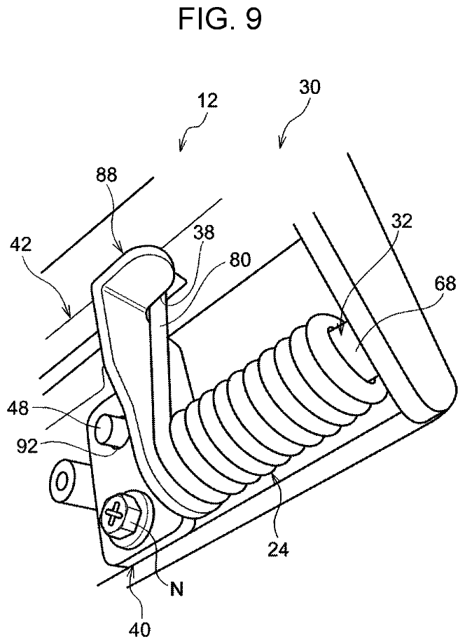

Then, as shown in FIG. 8, the torsion spring 34 is fitted on the shaft part 32, the coil portion 72 is moved along the fitting shaft 68, and the one-side extending portion 78 of the one-end portion 74 of the torsion spring 34 is inserted into the spring hole 202 in the arm portion 58 of the plate-like member 18 through the arc-shaped hole 56 in the frame component 42.

Next, the fitting shaft 68 of the shaft part 32 is inserted into the bearing portion 36 in the bracket 40. Then, as shown in FIG. 9, in a state in which the other-end portion 80 of the torsion spring 34 is pressed from above by the reaction-force receiving portion 38 of the bracket 40, the projection 48 provided on the frame component 42 is inserted into the positioning hole 92 in the bracket 40 so as to position the bracket 40.

In this positioned state, the screw N inserted into the screw hole 94 in the bracket 40 is screwed into the screw hole 50 provided in the frame component 42 by using a screwdriver, thus fixing the bracket 40.

FIG. 10 shows the positions of the one-side extending portion 78 of the one-end portion 74 of the torsion spring 34 when the plate-like member 18 is opened and closed. FIG. 10 shows an initial load position 100 where the one-side extending portion 78 is located in the closed state CS, and a high-load position 102 where the one-side extending portion 78 is located in the open state OP. FIG. 10 also shows a free position 104 where the one-side extending portion 78 is located when the torsion spring 34 is not inserted into the plate-like member 18 and thus is subjected to no load.

When the plate-like member 18 in the closed state CS is brought to the open state OP, the one-end portion 74 of the torsion spring 34 is rotated in the winding direction of the steel wire 70 about the central axis C of the coil portion 72, increasing the spring force acting in the direction of bringing the plate-like member 18 to the closed state CS. This spring force serves as the damping force mentioned above.

### Advantage and Effect

The advantages and effects of this exemplary embodiment will be described.

The attachment part 30 includes the bracket 40 having the bearing portion 36 that is fixed to the body 12 and supports the shaft part 32 and the reaction-force receiving portion 38 that receives a reaction force exerted by the other-end portion 80 of the torsion spring 34.

Hence, the parts count can be reduced, compared with a configuration in which a bearing and a spring presser are formed as separate members, and thus, the cost can be reduced.

Furthermore, the bracket 40 is made of a metal plate.

Hence, the bracket 40 is less likely to be broken, compared with a configuration in which the bracket 40 is made of a synthetic resin.

Moreover, the bracket 40 includes the fixing portion 82 fixed to the body 12, the upright portion 84 standing upright from the fixing portion 82 and constituting the bearing portion 36, and the side-edge extending portion 88 extending from the side edge of the upright portion 84 and constituting the reaction-force receiving portion 38.

Hence, the rigidity of the reaction-force receiving portion 38 is higher than that in a configuration in which the reaction-force receiving portion 38 is formed with a portion extending from an edge of the upright portion 84 opposite from the fixing portion 82.

The side-edge extending portion 88 extends from the side edge opposite from the side edge having the bearing portion 36.

Hence, it is possible to press the other-end portion 80, extending from the torsion spring 34 attached to the shaft part 32 of the bearing portion 36, at a position away from the central axis C of the coil portion 72. This reduces the reaction force applied to the side-edge extending portion 88, compared with a configuration in which the side-edge extending portion 88 extends from the side edge having the bearing portion 36.

Furthermore, the fixing portion 82 has two fixing holes 92 and 94. This suppresses unintentional rotation of the bracket 40, compared with a configuration in which one fixing hole is provided.

The fixing holes include the positioning hole 92 that receives the projection 48 provided on the body 12, and the screw hole 94 that receives the fixing screw N. The screw hole 94 is provided at a position farther from the body 12 than the positioning hole 92 is, in the direction HH.

Hence, compared with a configuration in which a portion of the fixing portion 82 closer to the body 12 is fixed with a screw, interference between a screwdriver for fixing the screw N and the body 12 is suppressed, thus improving the efficiency of screwing work.

In the image forming apparatus 10 according to this exemplary embodiment, the attachment structure is provided on the one side portion 24 side of the plate-like member 18 constituting the tray, and the mechanism 28 for transporting the medium P is provided on the other side portion 26 side of the plate-like member 18.

This simplifies the configuration, compared with a configuration in which both the attachment structure and the mechanism 28 for transporting the medium P are provided on the other side portion 26 of the tray.

### Second Exemplary Embodiment

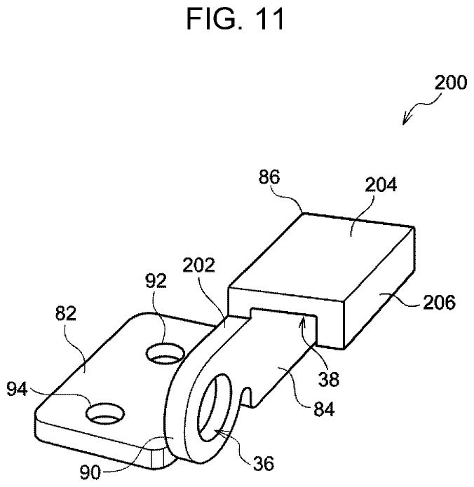

FIG. 11 shows a second exemplary embodiment. Portions equal to or similar to those in the first exemplary embodiment will be denoted by the same reference signs and will not be described, and portions different from those in the first exemplary embodiment will be described. In this exemplary embodiment, a bracket 200 used in the attachment part 30 is different from that in the first exemplary embodiment.

### Bracket

The bracket 200 according to this exemplary embodiment includes the rectangular fixing portion 82 fixed to the body 12 via the frame component 42, and the rectangular upright portion 84 standing upright from a long side of the fixing portion 82 and constituting the bearing portion 36. The bracket 200 has an upper-edge extending portion 204 extending from an upper edge 202 of the upright portion 84 toward the side opposite from the fixing portion 82 and constituting the reaction-force receiving portion 38.

The upright portion 84 has, near the other side edge 90, a circular hole constituting the bearing portion 36. The bearing portion 36 receives the fitting shaft 68 of the shaft part 32 to support the fitting shaft 68. The upper-edge extending portion 204 extends from the upper edge 202 of the upright portion 84 near the one side edge 86, which is opposite from the other side edge 90 having the bearing portion 36.

Flanges 206 extending downward in the thickness direction of the upper-edge extending portion 204 are formed on the edges of the upper-edge extending portion 204 so as to extend over the entire length to reinforce the upper-edge extending portion 204.

### Advantage and Effect

This exemplary embodiment provides the same effects as those obtained with the first exemplary embodiment, with regard to the configurations equal or similar to those according to the first exemplary embodiment.

The bracket 200 according to this exemplary embodiment has the upper-edge extending portion 204 extending from the upper edge 202 of the upright portion 84 and constituting the reaction-force receiving portion 38. Hence, compared with a configuration in which a side edge of the upright portion 84 is bent to form the reaction-force receiving portion 38, machining is easy.

More specifically, when a side edge of the upright portion 84 is bent to form the reaction-force receiving portion 38, the bending line along which the upright portion 84 is bent and the bending line along which the side edge of the upright portion 84 is bent intersect each other. Hence, a bending machine needs to re-hold the metal plate.

However, in this exemplary embodiment, the bending line along which the upright portion 84 is bent, the bending line along which the upper-edge extending portion 204 is bent, and the bending line along which the flanges 206 are bent extend in the same direction. Hence, the bending machine does not need to re-hold the metal plate.

The upper-edge extending portion 204 has the flanges 206 extending in the thickness direction of the upper-edge extending portion 204. This improves the rigidity of the upper-edge extending portion 204, compared with a configuration without the flanges 206.

Furthermore, the upright portion 84 and the flanges 206 inhibit movement of the other-end portion 80 of the torsion spring 34 pressed by the reaction-force receiving portion 38.

Although the bracket 40 is made of a metal plate in this exemplary embodiment, the bracket 40 may be made of a synthetic resin. Furthermore, although the configuration in which the plate-like member 18 is supported on the body 12 in a manner capable of being opened or closed has been described, the configuration is not limited thereto, and, for example, a cover may be supported on the body 12 in a manner capable of being opened or closed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An attachment structure comprising:
a shaft part via which a plate-like member is supported on a body in a manner capable of being opened or closed;
a torsion spring that is fitted on the shaft part with one end thereof fixed to the plate-like member and that exerts a damping force when the plate-like member is brought to an open state; and
a bracket having a bearing portion that is fixed to the body and supports the shaft part and a reaction-force receiving portion that receives a reaction force exerted by another end of the torsion spring.

2. The attachment structure according to claim 1, wherein the bracket is formed of a metal plate.

3. The attachment structure according to claim 2, wherein the bracket includes a fixing portion fixed to the body, an upright portion standing upright from the fixing portion and constituting the bearing portion, and a side-edge extending portion extending from a side edge of the upright portion and constituting the reaction-force receiving portion.

4. The attachment structure according to claim 3, wherein the side-edge extending portion extends from the side edge opposite from a side having the bearing portion.

5. The attachment structure according to claim 3, wherein the fixing portion has two fixing holes.

6. The attachment structure according to claim 4, wherein the fixing portion has two fixing holes.

7. The attachment structure according to claim 5, wherein the fixing holes include a positioning hole that receives a projection provided on the body and a screw hole that receives a fixing screw, the screw hole being provided at a position farther from the body than the positioning hole.

8. The attachment structure according to claim 6, wherein the fixing holes include a positioning hole that receives a projection provided on the body and a screw hole that receives a fixing screw, the screw hole being provided at a position farther from the body than the positioning hole.

9. The attachment structure according to claim 2, wherein the bracket includes a fixing portion fixed to the body, an upright portion standing upright from the fixing portion and constituting the bearing portion, and an upper-edge extending portion extending from an upper edge of the upright portion and constituting the reaction-force receiving portion.

10. The attachment structure according to claim 9, wherein the upper-edge extending portion has a flange extending in a thickness direction of the upper-edge extending portion.

11. An image forming apparatus comprising the attachment structure according to claim 1, wherein the plate-like member is a tray used to supply a medium on which an image is to be formed.

12. The image forming apparatus according to claim 11, wherein the attachment structure is provided on a one side portion of the tray, and a mechanism for transporting the medium is provided on another side portion of the tray.

13. The attachment structure according to claim 1, wherein:
when closed, the plate-like member extends along a side surface of the body so as to cover an opening in the side surface; and
when opened, the plate-like member projects sideward from the side surface so as to expose the opening.

14. The attachment structure according to claim 3, wherein the side-edge extending portion extends from the side edge of the upright portion toward an opposite side of the upright portion from the fixing portion.
